(19) United States
(12) Patent Application Publication
(10) Pub. No.: US 2015/0228032 A1
(43) Pub. Date: Aug. 13, 2015

(54) META-MODEL FOR MONITORING PAYROLL PROCESSES ACROSS A NETWORK

(71) Applicant: Fabian Guenther, Mauer (DE)

(72) Inventor: Fabian Guenther, Mauer (DE)

(21) Appl. No.: 14/176,680

(22) Filed: Feb. 10, 2014

(51) Int. Cl. G06Q 40/00

(52) U.S. Cl. CPC G06Q 40/125

(57) ABSTRACT

The present disclosure describes methods, systems, and computer program products for providing, to a graphical user interface at a client computing device, a modeling of one or more operations of a payroll process that are running across a network on one or more remote servers. A computer-implemented method for modeling one or more operations of a payroll process in a graphical user interface at a client computing device, the method may comprise: receiving, at a server and from the client computing device, a selection of an entity; receiving, at the server and from the client computing device, a selection of a time information; assigning, by the server, the selected entity and the selected time information to one or more operations of a payroll process; executing, by the server, the operation of the payroll process by using the selected entity and the selected time information; and providing, by the server to the client computing device, a status report about the execution of the operation of the payroll process.

### TECHNICAL FIELD

The present disclosure relates to software, computer systems, and computer-implemented methods for providing a modeling of one or more operations of a payroll process that are running across a network on one or more remote servers.

### BACKGROUND

Reflecting the enormous number of country-specific reports and sub-processes around payroll processes, there are usually thousands of transactions in a standard payroll. Given the heterogeneous country-specific legal regulations associated with payroll processes, there are large numbers of entities with relevance to each payroll process. The international main entity for a payroll process is the Payroll Area, a defined group of employees commonly selected for a regular payroll process. Usually there are additional, and often country-specific, entities for which parts of a payroll process are performed, like “employer” from a certain authority point of view. Often such a “legal employer” reflects a part of the organization for which reporting to an authority is done using the same employer identifier. The particular organizational split and the schedule for the corresponding sub-processes are heavily dependent on the country, the type of authority, and other relevant factors.

For instance, a company in Germany could have an employer identifier from an income tax point of view, with all tax reporting being done to the tax authority responsible for that company. Different kinds of tax declarations have to be sent on monthly as well as a yearly basis. On the other hand, from a social insurance point of view, the company is often split according to locations into different parts that are assigned different employer identifiers from the responsible authorities, with the corresponding communication with the authorities happening on a finer-granular level with different schedules, types of data, and other parameters.

In other countries, the situation may be similar, but with different types of authorities, company and organizational separations and assigned identifiers, communication schedules, etc. For example, the “Tax Company” in the US and the “Juristic Person” in the Netherlands are mentioned here, with partial quarterly reporting to the authorities.

All this leads to large numbers of different types of payroll processes—not only country-specific types, but different per industry segment, per customer, or even internal to a single company or organization (e.g., after a merger or acquisition, because of agreements with works councils, etc.). Often the work in the customers' payroll departments is specifically distributed, from one person de-centrally performing the whole payroll process for a payroll area to a shared central service that is responsible for multiple countries (e.g., one part of the service is responsible for payroll run, one for tax reporting, etc.). Often involved entities can only be indirectly derived, in particular in case of country-specific entities that are often reflected by lists of international entities like combinations of personnel area and sub-area.

### SUMMARY

The present disclosure describes computer-implemented methods, systems, and computer program products for providing, to a graphical user interface at a client device, a modeling of one or more operations of a payroll processes that are running across a network (e.g., a local area network, LAN, or a wide area network, WAN) on one or more remote servers.

One or more of the following aspects of this disclosure can be embodied alone or in combination as methods that include the corresponding operations. One or more of the following aspects of this disclosure can be implemented alone or in combination in a device comprising a processor, a processor-readable medium coupled to the processor having instructions stored thereon which, when executed by the processor, cause the processor to perform operations according to the one or more of the following aspects. One or more of the following aspects of this disclosure can be implemented alone or in combination on a computer program product encoded on tangible storage medium, the product comprising computer readable instructions for causing one or more computers to perform the operations according to the one or more of the following aspects.

In a general aspect 1, a computer-implemented method for modeling one or more operations of a payroll process in a graphical user interface at a client computing device is described, the method comprising: receiving, at a server and from the client computing device, a selection of an entity; receiving, at the server and from the client computing device, a selection of a time information; assigning, by the server, the selected entity and the selected time information to one or more operations of a payroll process; executing, by the server, the operation of the payroll process by using the selected entity and the selected time information; and providing, by the server to the client computing device, a status report about the execution of the operation of the payroll process.

Aspect 2 according to aspect 1, further comprising: receiving, at the server and from the client computing device, a selection of one or more result parameters; and determining, by the server, the selected one or more result parameters by using the operation of the payroll process.

Aspect 3 according to aspect 2, wherein the one or more result parameters includes at least one of: a number of errors in the executed payroll process, an identifier of the executed payroll process, a tax to be paid, a status of the payroll process, whether the operation has already been opened, is currently running or is closed and locked against changes, or log information about the operation.

Aspect 4 according to any one of aspects 1 to 3, wherein the executing of the operation of the payroll process by using the selected entity and the selected time information comprises: accessing, by the server, one or more databases including data associated with the selected entity or the selected time information, optionally wherein the one or more databases are communicatively connected with the server via a LAN or WAN.

Aspect 5 according to any one of aspects 1 to 4, wherein the assigning of the selected entity and the selected time information to one or more operations of a payroll process is performed by the server using the OData-protocol.

Aspect 6 according to any one of aspects 1 to 5, wherein the status report includes at least one of a degree to which the operation of the payroll process is or is not executed, a degree to which the payroll process is or is not executed, a degree to which the selected entity or the selected time information is processed by the operation of the payroll process, and a time required until the operation of the payroll process will be finished executing by using the selected entity and the selected time information.

Aspect 7 according to any one of aspects 1 to 6, wherein the time information is a time period or a point in time, and wherein the entity is one or more employees or a legal entity.

Aspect 8 according to any one of aspects 1 to 7, further comprising: receiving, by the server, a change to the operation of the payroll process and executing, by the server, the changed operation of the payroll process by using the selected entity and the selected time information either without having to change the modeling of the operation of the payroll processes in the graphical user interface at the client computing device or without having to reassign the selected entity and time information to the changed operation of the payroll process

Aspect 9 according to any one of aspects 1 to 8, wherein the operation of the payroll process is executed in a cloud computing environment or in an in-memory database.

Aspect 10 according to any one of aspects 1 to 9, further comprising: receiving, by the server, a command to add an additional operation of a payroll process to the executing operation of the payroll process to form a plurality of payroll process operations and executing, by the server, the plurality of payroll process operations by using the selected entity and the selected time information without having to reassign the selected entity and time information to the executing operation of the payroll process, or without having to change the modeling of the one or more operations of the payroll process in the graphical user interface at the client computing device.

Aspect 11 according to any one of aspects 1 to 10, wherein the client computing device and the server are connected via a wide area network connection, which has a latency time of more than 50 ms or of more than 100 ms.

The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example of a network environment.

FIG. 2 illustrates example payroll process.

FIG. 3 illustrates example graphical user interface at a client device

FIG. 4A illustrates an example meta-model for modeling a payroll process.

FIG. 4B illustrates an example meta-model for modeling a payroll process with particular input parameters.

FIG. 5A illustrates example graphical user interface at a client device for starting a new meta-model for a payroll process.

FIG. 5B illustrates example graphical user interface at a client device for receiving a selection of an entity and for receiving a selection of a time information.

FIG. 5C illustrates example graphical user interface at a client device for receiving a selection of exemplary result parameter types.

FIG. 6 illustrates example graphical user interface at a client device for specifying a received selection of an entity.

FIG. 7 illustrates example graphical user interface at a client device for receiving a status report about the execution of the payroll process.

FIG. 8 illustrates example computer-implemented method for modeling one or more operations of a payroll process in a graphical user interface at a client computing device

### DETAILED DESCRIPTION

This disclosure generally relates to software, computer systems, and computer-implemented methods for providing a modeling of one or more operations of a payroll process that are running across a network on one or more remote servers. Specifically, a flexible remote modeling of various payroll processes running across a network is provided, including to a client device. Implementations of the present disclosure described herein may provide one or more of the following advantages:

First, a meta-model configured to run within a graphical user interface on a client device (e.g., a mobile device) is provided, wherein the meta-model may be customized by the user of the client device without having to change the underlying operations of a payroll process.

Second, a meta-model configured to run within a graphical user interface on a client device (e.g., a mobile device) is provided, wherein the underlying operations of payroll processes may be modified or augmented without having to change the meta-model.

Third, the meta-model may be applied to various types of payroll processes taking place in various countries by using substantially the same meta-model. In this manner, the payroll processes and their operations may be unified by the meta-model.

Fourth, the monitoring via the meta-model may be performed on a mobile communications device (e.g., a tablet PC, mobile phone or smartphone), while the monitored payroll processes are executed in a remote network, e.g. in a cloud computing environment, e.g. distributed across several countries.

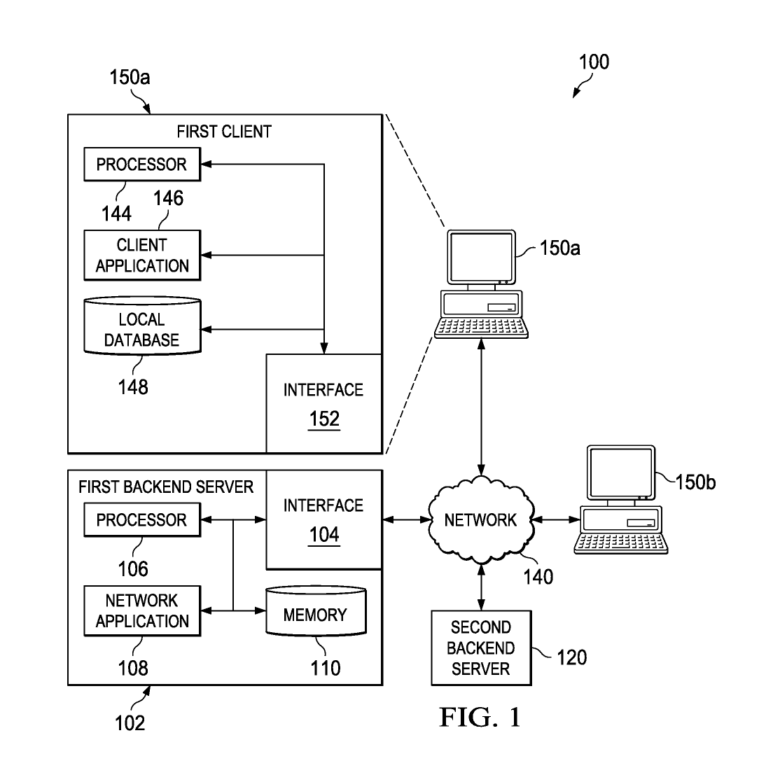

FIG. 1 illustrates an example environment 100 for implementing various features of a system for providing remote debugging across a wide area network to a software application which is running on a client device or in a cloud computing environment. The illustrated environment 100 includes, or is communicably coupled with, a (e.g., front-end) clients 150a, 150b, which represents a customer installation (e.g., an on-demand or an on-premise installation) or a user in a cloud-computing environment, and backend server systems 102, 120. In some instances, the front-end client 150a, 150b may co-reside on a single server or system, as appropriate. At least some of the communications between the client 150a and 150b and the backend servers 102, 120 may be performed across or via network 140 (e.g., via a LAN or wide area network (WAN) such as the Internet). In an aspect, environment 100 depicts an example configuration of a system for establishing business networks using networked applications built on a shared platform in a cloud computing environment, such as environment 100. The client 150a, 150b and/or the server 102, 120 include development technology and hosted and managed services and applications built on top of the underlying platform technology. In an implementation of the present disclosure described herein, the term “platform technology” is understood as types of Java development platform, such as e.g., Enterprise JavaBeans® (EJB), J2EE Connector Architecture (JCA), Java Messaging Service (JMS), Java Naming and Directory Interface (JNDI), and Java Database Connectivity (JDBC). In an implementation of the present disclosure described herein, the term “platform technology” comprises an SAP ByDesign platform, SuccessFactors Platform, SAP NetWeaver Application Server Java, ERP Suite technology or in-memory database such as High Performance Analytic Appliance (HANA) platform.

The illustrated environment 100 of FIG. 1 includes one or more (e.g., front-end) clients 150a, 150b. The client 150a, 150b may be associated with a particular network application or development context, as well as a particular platform-based application system. The clients 150a, 150b may be any computing device operable to connect to or communicate with at least one of the servers 102, 120 using a wireline or wireless connection via the network 140, or another suitable communication means or channel. In some instances, the client 150a—may be a part of or associated with a business process involving one or more network applications, or alternatively, a remote developer associated with the platform or a related platform-based application.

In general, the client 150a, 150b includes a processor 144, an interface 152, a client application 146 or application interface, a graphical user interface (GUI), and a memory or local database 148. In general, the client 150a, 150b includes electronic computer devices operable to receive, transmit, process, and store any appropriate data associated with the environment 100 of FIG. 1. As used in this disclosure, the client 150a, 150b is intended to encompass a personal computer, laptop, tablet PC, workstation, network computer, kiosk, wireless data port, smart phone, personal data assistant (PDA), one or more processors within these or other devices, or any other suitable processing device. The client or tenant 150a, 150b may be a mobile communication device. For example, the client 150a, 150b may comprise a computer that includes an input device, such as a keypad, touch screen, mouse, or other device that can accept user information, and an output device that conveys information associated with the operation of one or more client applications, on-demand platforms, and/or the client 150a, 150b itself, including digital data, visual information, or GUI.

Both the input and output device may include fixed or removable storage media such as a magnetic storage media, CD-ROM, or other suitable media, to both receive input from and provide output to users of client 150a, 150b through the display, namely, the GUI. The client application 146 or application interface can enable the client 150a, 150b to access and interact with applications and modules in backend server systems using a common or similar platform. The client application 146 allows the client 150a, 150b to request and view content on the client 150a, 150b. In some implementations, the client application 150a, 150b can be and/or include a web browser. In some implementations, the client application 146 can use parameters, metadata, and other information received at launch to access a particular set of data from the server 102, 120. Once a particular client application 146 is launched, the client can process a task, event, or other information which may be associated with the server 102, 120. Further, although illustrated as a single client application 146, the client application 146 may be implemented as multiple client applications in the client 150a, 150b.

There may be any number of clients 150a, 150b associated with, or external to, environment 100. For example, while illustrated environment 100 includes one client 150a, 150b, alternative implementations of environment 100 may include multiple clients communicably coupled to the one or more of the systems illustrated. In some instances, one or more clients 150a, 150b may be associated with administrators of the environment, and may be capable of accessing and interacting with the settings and operations of one or more network applications, and/or other components of the illustrated environment 100. Additionally, there may also be one or more additional clients 150a, 150b external to the illustrated portion of environment 100 capable of interacting with the environment 100 via the network 140. Further, the terms “client,” “customer,” and “user” may be used interchangeably as appropriate without departing from the scope of this disclosure. Moreover, while the client 150a, 150b is described in terms of being used by a single user, this disclosure contemplates that many users may use one computer, or that one user may use multiple computers. In general, clients may usually belong to one customer or company. Several employees of the customer, called users, can use the applications deployed on the corresponding client. For instance, the term “client” refers to a system providing a set of client applications belonging to or rented by a particular customer or business entity. Several employees of that particular customer or business entity can be users of that client and use the network applications provided by or available on this client.

The data stored in the local database 148 may be locked and accessed by the first backend server 102, and interacted with the front-end client 150a, 150b. In other instances, the data may be used by a network application 108 associated with one of the other backend servers 120 for processing applications associated with those systems. For example, one or more of the components illustrated within the backend servers 102, 120 may be located in multiple or different servers, cloud-based or cloud computing networks, or other locations accessible to the backend servers 102, 120 (e.g., either directly or indirectly via network 140). For example, each backend server 102, 120 and/or client 150a, 150b may be a Java 2 Platform, Enterprise Edition (J2EE)-compliant application server that includes technologies such as Enterprise JavaBeans® (EJB), J2EE Connector Architecture (JCA), Java Messaging Service (JMS), Java Naming and Directory Interface (JNDI), and Java Database Connectivity (JDBC). In some instances, each of the backend servers 102, 120 may store a plurality of various applications, while in other instances, the backend servers 102, 120 may be dedicated servers meant to store and execute certain network applications built based on the on-demand platform using the on-demand platform technology and on-demand platform business content. In some instances, the backend servers 102, 120 may include a web server or be communicably coupled with a web server, where one or more of the network applications 108 associated with the backend servers 102, 120 represent web-based (or web-accessible) applications accessed and executed through requests and interactions received on the front-end client 150a, 150b operable to interact with the programmed tasks or operations of the corresponding on-demand platform and/or network applications.

At a high level, the backend servers 102, 120 include an electronic computing device operable to receive, transmit, process, store, or manage data and information associated with the environment 100. The backend servers 102, 120 illustrated in FIG. 1 can be responsible for receiving requests from one or more clients 150a, 150b (as well as any other entity or system interacting with the backend servers 102, 120, including desktop or mobile client systems), responding to the received requests by processing said requests in an on-demand platform and/or an associated network application, and sending the appropriate responses from the appropriate component back to the requesting front-end client 150a, 150b or other requesting system. Components of the backend servers 102, 120 can also process and respond to local requests from a user locally accessing the backend servers 102, 120. Accordingly, in addition to requests from the front-end client 150a, 150b illustrated in FIG. 1, requests associated with a particular component may also be sent from internal users, external or third-party customers, and other associated network applications, business processes, as well as any other appropriate entities, individuals, systems, or computers. In some instances, either or both an on-demand platform and/or a network application may be web-based applications executing functionality associated with a networked or cloud-based business process.

As used in the present disclosure, the term “computer” is intended to encompass any suitable processing device. For example, although FIG. 1 illustrates three backend servers 102, 120, environment 100 can be implemented using any number of servers, as well as computers other than servers, including a server pool. Indeed, the backend servers 102, 120 and/or the clients 150a, 150b may be any computer or processing device such as, for example, a blade server, general-purpose personal computer (PC), Macintosh®, workstation, UNIX®-based workstation, or any other suitable device. In other words, the present disclosure contemplates computers other than general purpose computers, as well as computers without conventional operating systems. Further, the illustrated backend servers 102, 120 may be adapted to execute any operating system, including Linux®, UNIX®, Windows®, Mac OS®, or any other suitable operating system.

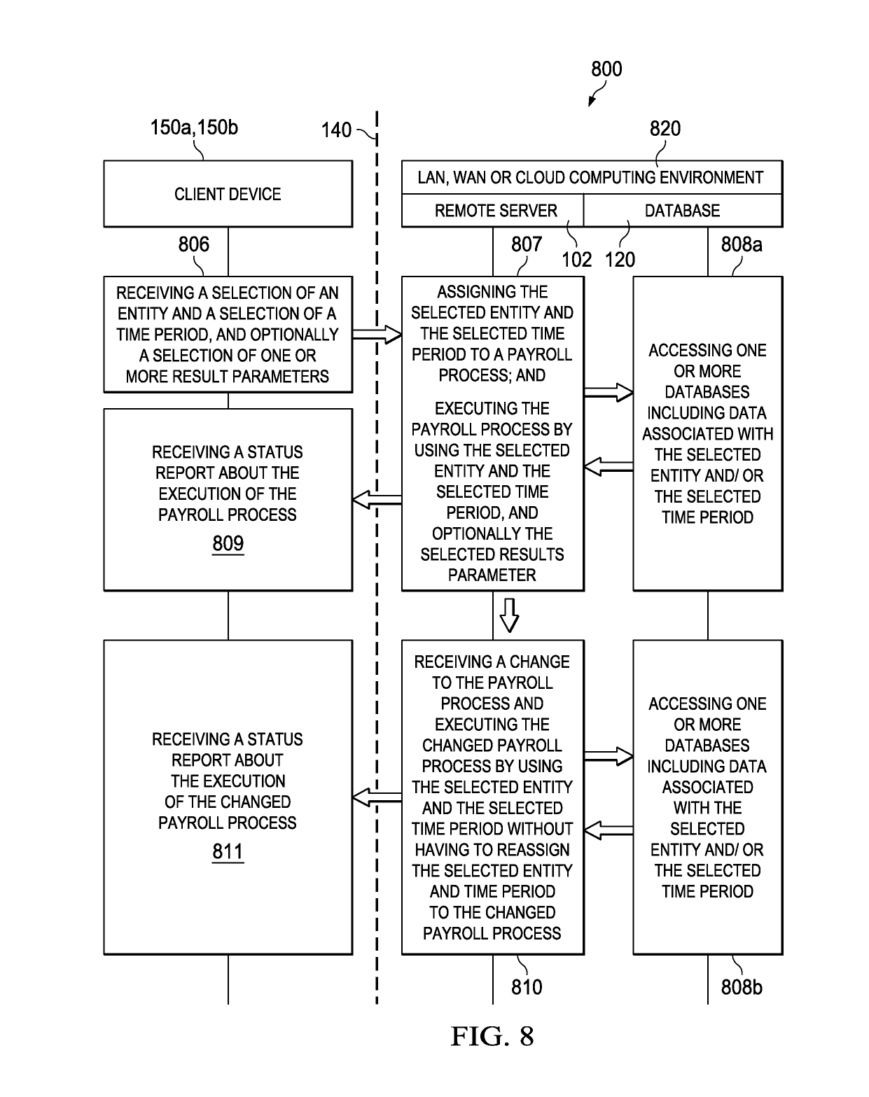

The first backend server 102 is illustrated in details in FIG. 1. The first backend server 102 includes an interface 104, a processor 106, a memory 110, a network application 108, and other components further illustrated in FIG. 8. In some instances, the backend servers 102, 120 and its illustrated components may be separated into multiple components executing at different servers and/or systems. For example, while FIG. 1 illustrates the network application 108 and the processor 106 as separate components, other example implementations can include the processor 106 within a separate system, as well as within as part of the network application's inherent functionality. Thus, while illustrated as a single component in the example environment 100 of FIG. 1, alternative implementations may illustrate the backend servers 102, 120 as comprising multiple parts or portions accordingly.

In FIG. 1, the interface 104 is used by the first backend server 102 to communicate with other systems in a client-server or other distributed environment (including within environment 100) connected to the network 140 (e.g., one of the front-end clients 150a, 150b, as well as other clients or backend servers communicably coupled to the network 140). The term “interface” 104, 152 generally includes logic encoded software and/or hardware in a suitable combination and operable to communicate with the network 140. More specifically, the interface 104 may comprise software supporting one or more communication protocols associated with communications such that the network 140 or the interface's hardware is operable to communicate physical signals within and outside of the illustrated environment 100. Generally, the backend servers 102, 120 may be communicably coupled with a network 140 that facilitates wireless or wireline communications between the components of the environment 100 (e.g., among the backend servers 102, 120 and/or one or more front-end clients 150a, 150b), as well as with any other local or remote computer, such as additional clients, servers, or other devices communicably coupled to network 140, including those not illustrated in FIG. 1. In the illustrated environment, the network 140 is depicted as a single network, but may be comprised of more than one network without departing from the scope of this disclosure, so long as at least a portion of the network 140 may facilitate communications between senders and recipients. In some instances, one or more of the components associated with the backend servers 102, 120 may be included within the network 140 as one or more cloud-based services or operations.

The term “network” refers to all or a portion of an enterprise or secured network, while in another instance, at least a portion of the network 140 may represent a connection to the Internet. In some instances, a portion of the network 140 may be a virtual private network (VPN). Further, all or a portion of the network 140 can include either a wireline or wireless link. Example wireless links may include 802.11a/b/g/n, 802.20, WiMax®, and/or any other appropriate wireless link. In other words, the network 140 encompasses any internal or external network, networks, sub-network, or combination thereof operable to facilitate communications between various computing components inside and outside the illustrated environment 100. The network 140 may communicate, for example, Internet Protocol (IP) packets, Java Debug Wire Protocol (JDWP), Frame Relay frames, Asynchronous Transfer Mode (ATM) cells, voice, video, data, and other suitable information between network addresses. The network 140 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, the first backend server 102 includes a processor 106. Although illustrated as a single processor 106 in the backend server 102, two or more processors may be used in the backend server 102 according to particular needs, desires, or particular embodiments of environment 100. The backend servers 120 and 102, as well as other backend systems, may similarly include one or more processors. The term “processor” refers to a central processing unit (CPU), a blade, an application specific integrated circuit (ASIC), a field-programmable gate array (FPGA), or another suitable component. Generally, the processor 106 executes instructions and manipulates data to perform the operations of the backend server 102, and, specifically, the functionality associated with the corresponding network application 108. In one implementation, the server's processor 106 executes the functionality required to receive and respond to requests and instructions from the front-end client 150a, 150b, as well as the functionality required to perform the operations of the associated network application 108 and an on-demand platform, among others.

At a high level, the term “software application” and “networked application” described in this specification refer to any application, program, module, process, or other software that may execute, change, delete, generate, or otherwise manage information associated with the server 102, 120 or the client device 150a, 150b, and in some cases, a business process performing and executing business process-related events. In particular, business processes communicate with other users, applications, systems, and components to send, receive, and process events. In some instances, a particular network application 108 may operate in response to and in connection with one or more requests received from an associated client or other remote client. Additionally, a particular network application 108 may operate in response to and in connection with one or more requests received from other network applications external to the backend server 102. In some instances, the network application 108 can be a networked application, for example, the network application 108 is built on a common platform with one or more applications in either or both of the backend servers 120 and 102. In some instances, the network application 108 may request additional processing or information from an external system or application. In some instances, each network application 108 may represent a web-based application accessed and executed by the front-end client 150a, 150b via the network 140 (e.g., through the Internet, or via one or more cloud-based services associated with the network application 108).

Further, while illustrated as internal to the backend server 102, one or more processes associated with a particular network application 108 may be stored, referenced, or executed remotely. For example, a portion of a particular network application 108 may be a web service that is remotely called, while another portion of the network application 108 may be an interface object or agent bundled for processing at a remote system. Moreover, any or all of a particular network application 108 may be a child or sub-module of another software module or enterprise application (e.g., the backend servers 120 and 130). Still further, portions of the particular network application 108 may be executed or accessed by a user working directly at the backend servers 102, as well as remotely at corresponding front-end client 150a, 150b.

Regardless of the particular implementation, “software” may include computer-readable instructions (e.g., programming code), firmware, wired or programmed hardware, or any combination thereof on a tangible and non-transitory medium operable when executed to perform at least the processes and operations described herein. Indeed, each software component may be fully or partially written or described in any appropriate computer language including C, C++, Java®, Visual Basic®, assembler, Perl®, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated environment 100, the processor 106 executes the corresponding network application 108 stored on the associated backend servers 120. In some instances, a particular backend server may be associated with the execution of two or more network applications (and other related components), as well as one or more distributed applications executing across two or more servers executing the functionality associated with the backend servers.

The server 102, 120 may process data input received from the client devices 150a, 150b by using the Open Data Protocol (OData), which is a data access protocol. The OData protocol was designed to provide standard create, read, update, and delete access to a data source via a website. OData may be used to access table-like structures similar to the way Structured Query Language (SQL) does, wherein an OData service may correspond to a database schema and an entity may correspond to database table. Customers (e.g., users of client devices 150a, 150b) may run on-premise systems in hybrid landscapes together with on-demand systems, consuming data from both.

In some implementations, the server 102, 120 can communicate with client device 150a, 150b using the OData protocol through hypertext transfer protocol (HTTP) or hypertext transfer protocol secure (HTTPS) requests. In some implementations, the server 102, 120 can use a remote function call (RFC) interface to communication with advanced business application programming (ABAP) language and/or non-ABAP programs.

FIG. 1 further includes memory 110 in the backend server 102. For example, the backend server 102 can host a master application for a particular data object, which is stored at the memory 110. The data object stored at the memory 110 may be accessed by other networked applications, for example, by applications of the backend servers 120 and 102. The data access does not require data replication and therefore can be stored at a single location (e.g., the memory 110). In addition, the memory 110 of the backend server 120 stores data and program instructions for the network application 108. The term “memory” refers to any memory or database module and may take the form of volatile or non-volatile memory including, without limitation, magnetic media, optical media, random access memory (RAM), read-only memory (ROM), removable media, or any other suitable local or remote memory component.

The memory 110 may store various business objects, object models, and data, including classes, frameworks, applications, backup data, business objects, jobs, web pages, web page templates, database tables, process contexts, repositories storing services local to the backend server 120 and any other appropriate information including any parameters, variables, algorithms, instructions, rules, constraints, or references thereto associated with the purposes of the backend server 120 and its functionality. In an aspect, the term “business object” is a representation of an intelligible business or non-business entity, such as an account, an order, employee, an invoice or a financial report. In some implementations, including in a cloud-based system, some or all of the memory 110 may be stored remote from the backend server 120 and communicably coupled to the backend server 120 for usage. As described above, memory 110 can include one or more meta-models associated with various objects included in or associated with the underlying platform. Specifically, memory 110 can store items and entities related to the network application 108 and/or other collaboration-related entities or components. Some or all of the elements illustrated within memory 110 may be stored external to the memory 110. These items may be made accessible within the network environment as illustrated in FIG. 8.

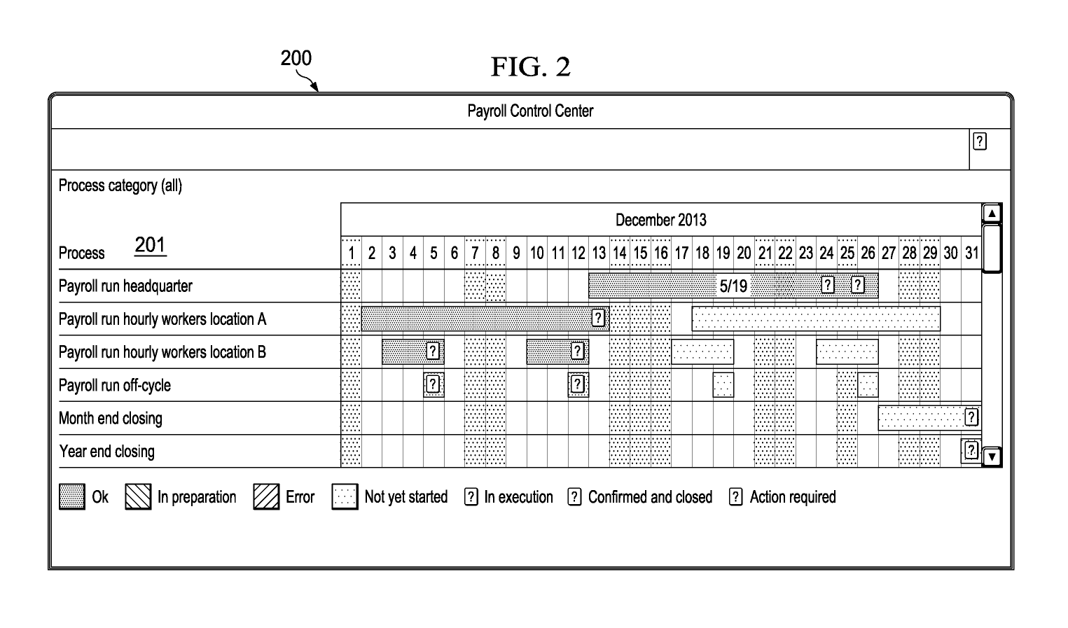

FIG. 2 illustrates example operations of payroll processes 201 in a graphical user interface 200. As outlined above, given the heterogeneous country-specific and entity-specific legal regulations around payroll processes, there are large numbers of entities with relevance to each payroll process. Also, cultural differences make payroll processes complex to monitor and control. To summarize, the simple scenario “I have the task to create a report R for legal entity E at location A” has a very complex and unnatural translation to the existing system language of payroll processes. As interface 200 illustrates, temporal considerations also may play a role in executing payroll processes. For example, legal changes may affect payroll processes at various times in a time-dependent manner.

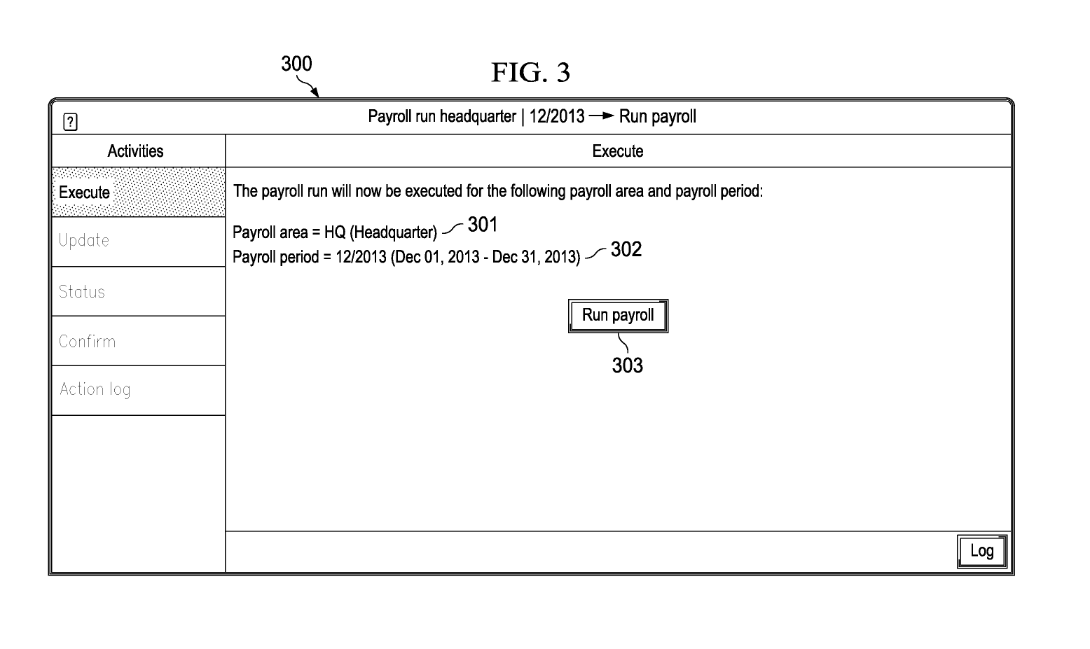

FIG. 3 illustrates example graphical user interface 300 at a client device for initializing execution of a payroll process for a particular payroll area 301 and a particular payroll period 302. It may be desirable that a user at a client device (e.g., client device 150a, 150b) may initialize execution of a payroll process by activating icon 303, wherein the payroll process may be executed on a remote server 102.

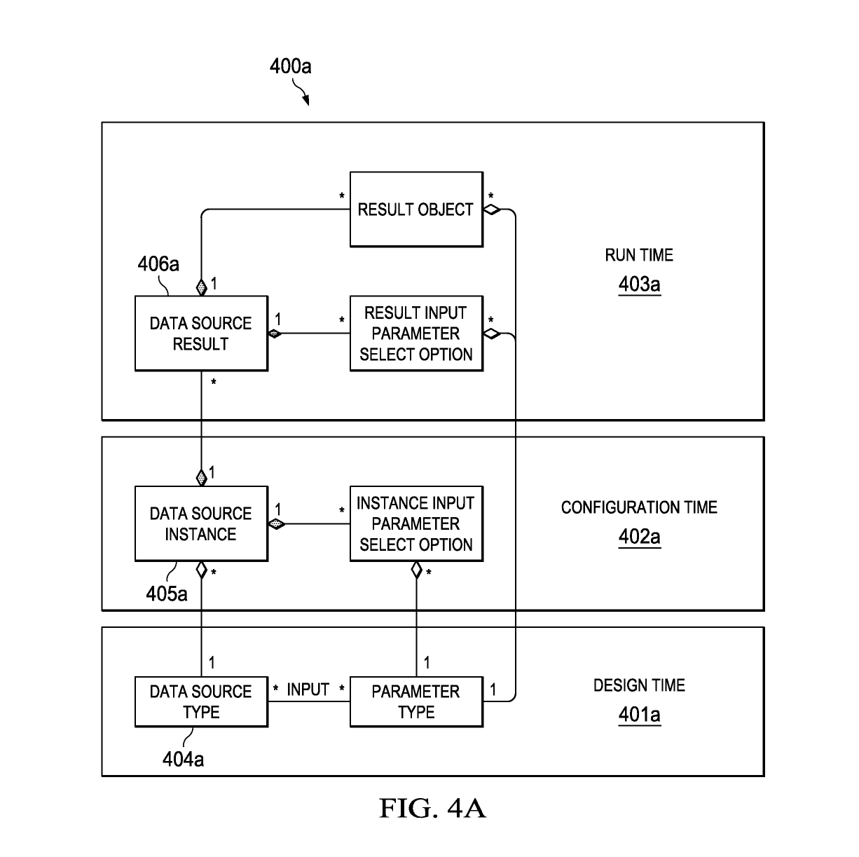

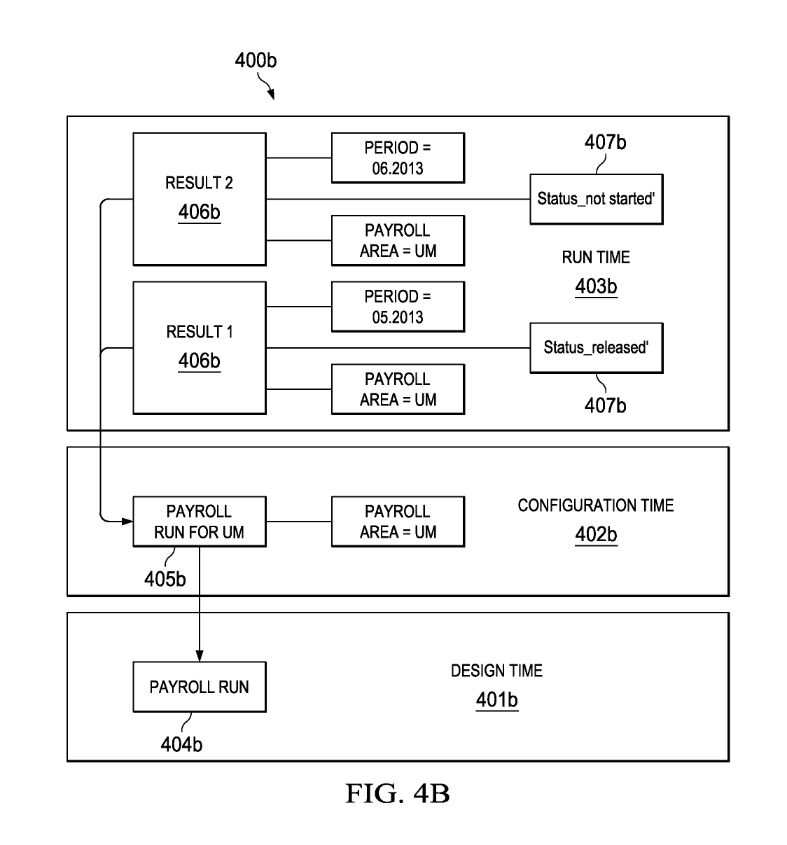

FIG. 4A illustrates an example meta-model 400a for modeling a step or an operation of a payroll process, and FIG. 4B illustrates an example meta-model 400b for modeling a step or an operation of a payroll process with particular input parameters. In a general aspect of the meta-model, the meta-model is implemented as a computer-implemented method for modeling one or more steps or operations of a payroll process in a graphical user interface at a client computing device (e.g., client devices 150a, 150b), the method comprising: receiving, at the graphical user interface, a selection of an entity; receiving, at the graphical user interface, a selection of a time information (e.g., a time period and/or a point in time); assigning, by a server (e.g., server 102, 120) remote to the client computing device, the selected entity and the selected time information to a step of a payroll process; executing, by the server, the step or operation of the payroll process by using the selected entity and the selected time information; and receiving, at the graphical user interface, a status report about the execution of the step of the payroll process.

In an aspect of the meta-model, one or more steps or operations of the payroll process, here exemplary called “Data Sources,” are modeled. For example, the statement “I am responsible for payroll process steps A, B, C” can then be translated into “I am authorized for Data Sources X, Y, Z,” where Data Source X covers the required functionality of process step A, etc. Examples for different kinds of data as well as operations that can be performed by the meta-model may be:
“Employees assigned to the payroll area, having a claim in payroll period or payroll point in time”. The corresponding input data provided to the meta-model may be:
   selected entity=payroll area (e.g. “Germany”, “USA”, “UM” etc.), selected time information (here exemplary “May 2013”), and/or
   List of corresponding employees, and/or
   For each employee, list of relevant wage types from the payroll result, like total gross, statutory and other deductions, claim amount.
“Main process control for the payroll area”. Data provided:
   Status and period from payroll area control record.
Operations
   “Release for payroll,” “Set to correction phase,” etc. (note: list of active operations depends on the control record status)
“Yearly Tax Declaration for Employer E, year J”. Data provided:
   Status.
   File that has to be sent to the corresponding tax authority.

Exemplary operations performed by the meta-model may be one or more of the following: create file (e.g., starting a batch process), send file to payroll or tax authority, change status (e.g., to “done” or “in progress”).

### Data Source Types

In an aspect of the meta-model, a Data Source Type 404a (in FIG. 4A) or 404b (in FIG. 4B) is created during the design time 401 a (in FIG. 4A) or—401b (in FIG. 4B) (e.g., during pre-configuration of the meta-model before it is shipped or made accessible to the user of client device 150a, 150b) describes a Data Source on type level and is a design time entity that can be delivered from a development system. It may use Parameter Types to formulate their input as well as result data. The Data Source Types for the example in FIG. 4B may be:
Data Source Type “Employees with Claim”
   Input Parameter Types:
      Payroll Area: the value can be defined by the user of client device 150a, 150b when configuring the payroll process.
      Payroll Period: the value of this one may be flexible and may depend for instance on the status of the payroll area control record in the production system.
   Result Parameter Type:
      Personnel Number.
   Result Details Types:
      <Category: Data> Header info for an employee.
      <Category: Data> List of amounts for total gross, statutory deductions, other deductions, claim.
      <Category: Operation on list level> Refresh list of employees.
Data Source Type “Main Process Control”
   Input Parameter Types:
      Payroll Area.
   Result Parameter Types:
      Payroll Area.
   Result Details Types:
      <Category: Data> Header info for payroll area.
      <Category: Data> Status and period from control record.
      <Category: Operation> Release for Payroll.
Data Source Type “Tax Declaration”
   Input Parameter Types:
      Legal Employer.
      Year.
   Result Parameter Types:
      Status.
      Tax Declaration File.
   Result Details Types:
      <Category: Data> Header info for Tax Declaration File.
      <Category: Data> Content of Tax Declaration File.
      <Category: Data> Detailed status information about communication with authorities.
      <Category: Data> Status information about file creation and step completeness.
      <Category: Operation> (Re-)Create file in batch.
      <Category: Operation> Send file to authority.
      <Category: Operation> Set step to “done.”

In an aspect, the Data Source Type implementation may calculate the result object list (typed with the Result Parameter Type) based on input parameter values (typed with the Input Parameter Types). It also has to provide the data or execute the operation reflecting the Result Details Type.

### Data Source Classification

In an aspect of the meta-model, in order to classify Data Source Types, the meta-model may introduce the possibility for the user of client device 150a, 150b to define Data Source Classes that combine a certain list of Data Source Types. Subgrouping may be possible via Folders that also allow a hierarchical structure. Data Source Classes may be design time entities, that is, they can be delivered by developers, and they can be extended and created in client devices 150a, 150b.

Examples are Data Source Classes that include of Data Source Types reflecting consistency checks on master data or payroll results (those classes are the bases for the new so-called Payroll Cockpit user interface). Folders may semantically group those checks.

In an aspect, the meta-model may also allow to cover a whole end-to-end payroll process for a certain market segment using a Data Source Class, where the Folders reflect the main steps; the Data Source Types reflect the atomic individual steps.

### Data Source Instances

In an aspect of the meta-model, with the creation of Data Source Instances 405a, 405b during the configuration time 402a, 402b (e.g., during adjusting of the meta-model by the user of the client device 150a, 150b and after it is shipped or made accessible to the user of client device 150a, 150b), the customer may decide for using a Data Source Type for a specific entity value, like using Data Source Type “Main Process Control” for payroll area UM. In an aspect of the meta-model, authorization to access Data Source Instances can be assigned to users. For instance, in the mentioned example assigning Data Source Instance “Main Process Control for payroll area UM” to user A can be interpreted as “User A is responsible and authorized for controlling the main process flow for payroll area UM.” In an aspect of the meta-model and in order to differentiate between users who have to have read access to a Data Source Instance and who need to execute operations on the Data Source Instance, finer-granular authorizations can be granted.

### Mapping

In an aspect of the meta-model, the assigning or mapping of a portion of the meta-model (e.g., the selected entity and/or the selected time information) to a step or operation of the payroll process may include one or more of the following entities:
“Payroll Process Step Template”: describes the type of one step of a payroll process, like “regular payroll run” or “payslip printing for Austria”. It may also contain information about the required input parameter types like “Payroll Area” and “Payroll Period”.
   A “Payroll Process Step” uses a Payroll Process Step Template and may run for a specific value of the main selection parameter type (“Payroll Area=A”). It may describe how a customer organizes this payroll process step for a group of employees based on the template.
   A “Payroll Process Step Instance” may describe the execution of a Payroll Process Step for a certain payroll period (or another time dimension like a point in time), e.g., checking the payroll results for payroll area A and payroll period 01.2014.
“Payroll Process Template”: the type of an end-to-end payroll process like “regular payroll run for Russia”, “Quarterly Tax Reporting in the US” or “regular payroll process for the public sector in Singapore”. It may consist of various Step Templates, grouped into Payroll Process Step Group Templates and brought into a defined order.
   A “Payroll Process” may use a Payroll Process Template and may run for a specific value of the main selection parameter type (“Payroll Area=A”). It may describe how a customer organizes the whole payroll process (not only individual steps) for a group of employees based on that template.
   A “Payroll Process Instance” may describe the execution of a whole payroll process for a certain payroll period, like “regular payroll process for January 2014 for the public servants in Munich”. It may contain one or more process step instances.
The mapping to the meta-model:
   Payroll Process Template->Data Source Class.
   Payroll Process Step Group Template->Folder
   Payroll Process Step Template->Data Source Type
   Payroll Process Step->Data Source Instance
   Payroll Process Step Instance->Data Source Result
   Generalized selection entity (sub types: Payroll Area, US Tax Company etc.)->Instance Selection Parameter Type of the Data Source Class (and of the Data Source Type)
   Generalized time selection entity (sub types: Payroll Period, Quarter etc.)->Time Selection Parameter Type of the Data Source Class (and of the Data Source Type)
   Payroll Process, Payroll Process Step Group, Payroll Process Instance and Payroll Process Step Group Instance may or may not have a mandatory counterpart in the meta-model. They may be derived on existing configuration or a rule evaluation.
      If at all, the relationship Payroll Process <-> Payroll Process Template & Instance Selection Parameter Value may have to be configured. Additionally usually the “Process Period” has to be assigned to the Payroll Process Instance (and—if required—the Payroll Process Step Group Instance).

In an aspect of the meta-model, the assigning or mapping of a portion of the meta-model (e.g., the selected entity and/or the selected time information) to a step or operation of the payroll process may include one or more of the following operations 1 to 3 of an algorithm:
1. Determine a list of time parameter values for a given selected entity, for instance:
   a. Main selection entity “Payroll Area A” has payroll periods 01.2014 (effective dates 2014-01-01 . . . 2014-01-31)/02.2014 (2014-02-01 . . . 2014-02-28)/etc.
   b. “US Tax Companies” has quarters 1.2014 (2014-01-01 . . . 2014-03-31)/2.2014 (2014-04-01 . . . 2014-06-30)/etc.

Such time parameter values may either be determined based on some configurable rules or are manually maintained by the user of the client device 150a, 150b, and may be based on the corresponding Instance Selection Parameter Type. Typically payroll systems may have such configuration already stored in meta data.
2. Determine, for each time parameter value, when the corresponding operation of the payroll process is planned to run (e.g., called “process period”), for instance
   a. The whole regular process for Payroll Area A, payroll period 1.2014 runs between 2014-01-14 and 2014-02-05.
   b. The quarter-end processing for Tax Company US01, quarter Q1.2014 runs between 2014-03-28 and 2014-04-15.

Such information (“process period”) may either be determined based on some configurable rules or are manually maintained by the user of the client device 150a, 150b.
3. Requesting, from the client 150a, 150b to the server 102, 120, data shown in FIG. 2. Input data is mainly the user and selection period (like “December 2013”). The server may authenticate the user, select all payroll process instances the process period of which overlaps with the specified selection period and for which the user is authorized. With each process instance, a unique identifier may be returned, together with the data connected (for instance: process instance ID, name, payroll area, payroll period, effective dates, “process period” etc.). The client displays the data in the way shown in FIG. 2. If the user clicks on one process instance, the requests from the client to the server may (e.g. only) use the process instance ID to tell the server for which process instance the details are requested. The individual process steps and their groupings can be derived by the server by looking at the Process Template and the Step Group Templates (Data Source Class+Folders) assigned to that Process Instance and by looking at the Process Step Instances (Data Source Results) valid for the main selection entity of the Process Instance. As the Process Step Instances have individual status information, the status on higher level (Step Group Instance & Process Instance) can be derived via aggregation of the individual statuses. All such info can be returned by the server.

### Data Source Results

In an aspect of the meta-model, an exemplary method may further comprise: receiving, at the graphical user interface, a selection of one or more result parameters 406a, 400b and determining, by the remote server (e.g. during the run time 403a, 403b), the selected one or more result parameters by using one or more operations of the payroll process. In an aspect, the one or more result parameters includes at least one of a number of errors in the executed payroll process, an identifier of the executed payroll process, a tax to be paid, or a status of the payroll process. In an aspect of the meta-model, one may want to distinguish process instances like “Regular US Payroll Process for Period May 2013” and “Regular US Payroll Process for Period June 2013”. Figuratively, the meta-model may “calculate” the result of a Data Source Instance when fully specifying the (mandatory) input parameters according to its Data Source Type. In an aspect of the meta-model, for typical Data Source Instances such as “Employees with Claim in payroll area UM,” we have the fixed input parameter “payroll area UM” but the list of employees likely differs between different payroll periods. This is handled via the additional (mandatory, but not necessarily fixed) input parameter type “Period.” For example: The list of employees with claims for payroll area UM, period May 2013 is the list of result objects of parameter type “Personnel Number” that are calculated by the Data Source Type “Employees with Claims” when using “payroll area=UM” and “Period=May 2013” as input parameter values.

In an aspect of the meta-model, a process operation instance in the meta-model may be the result of a calculation of a Data Source Type for the input parameter values configured in the corresponding Data Source Instance in addition to values for further mandatory input parameter types that have not been specified by the Data Source Instance. A Data Source Result therefore may comprise the full list of mandatory input parameter values (or—more general—select options) used to calculate the result and/or lists of result objects, typed with the result parameter types of the corresponding Data Source Type. In an aspect, these lists may be returned by the calculation of the Data Source Type using the before-mentioned list of mandatory input parameter values.

In an aspect of the meta-model, the status report 407b obtained at runtime 403a, 403b may include at least one of a degree to which the payroll process is executed, a degree to which the payroll process is not executed; a degree to which the selected entity or the selected time information is processed by the payroll process; and a time required until the payroll process will be finished executing by using the selected entity and the selected time information. In an aspect of the meta-model, the Data Source Result and its sub entities may allow assigning status, workflow, and other suitable parameters values to concrete process steps. They may also provide automated calculations, such as status aggregations, along the hierarchies on top (e,g, Data Source Instance, Folders, and Data Source Classes). Such calculations can be well-supported by the meta-model as this may simplify the corresponding algorithms and allow for synchronous execution of calculations on-the-fly. Depending on how the data persistency is designed, the payroll process may also be implemented in an in-memory database for redundancy-free real-time analysis of such payroll operational data. The status report 407b or 700 may include one or more of the following:
Step Instance:
   Execution Status and Error Status (see 807).
   List of allowed operations on the step instance based on its current status (e.g. “Open Step Instance” only allowed if Execution status is “Not Started”, etc.). Translation into meta-model: List of active Result Details Types for given Result Parameter.
Step Group Instance (Data Source Result+Data Source Class & Folder+eventually some additional rules & configuration for the “process period”, if required):
   aggregated Execution Status (with the canonical aggregation algorithm like: if all steps “not started”->aggregated status not started/elseif at least one step “in execution”->“in execution”/else if all steps “closed”->“closed”), link to open Step Instance(s)
   aggregated Error Status (canonical aggregation algorithm), link to Step Instance(s) with error
   “Process Period” (see above, “step group instance is planned to run between 2014-02-14 and 2014-02-19”)
   Number of step instances closed, total number of step instances
Process Instance (Data Source Result+Data Source Class+eventually some additional rules & configuration, if required):
   aggregated Execution Status, link to open Step Instance(s)
   aggregated Error Status, link to Step Instance(s) with error
   “Process Period”
   Number of step instances closed, total number of step instances
For all:
   main selection entity (“Payroll Area=A”), time selection parameter value (“Payroll Period=01.2014”)+texts (“Regular Payroll Process for public servants in Munich” etc.)
   Action Log (for Step Group Instance and Process Instance aggregated based on the action logs of the individual steps)

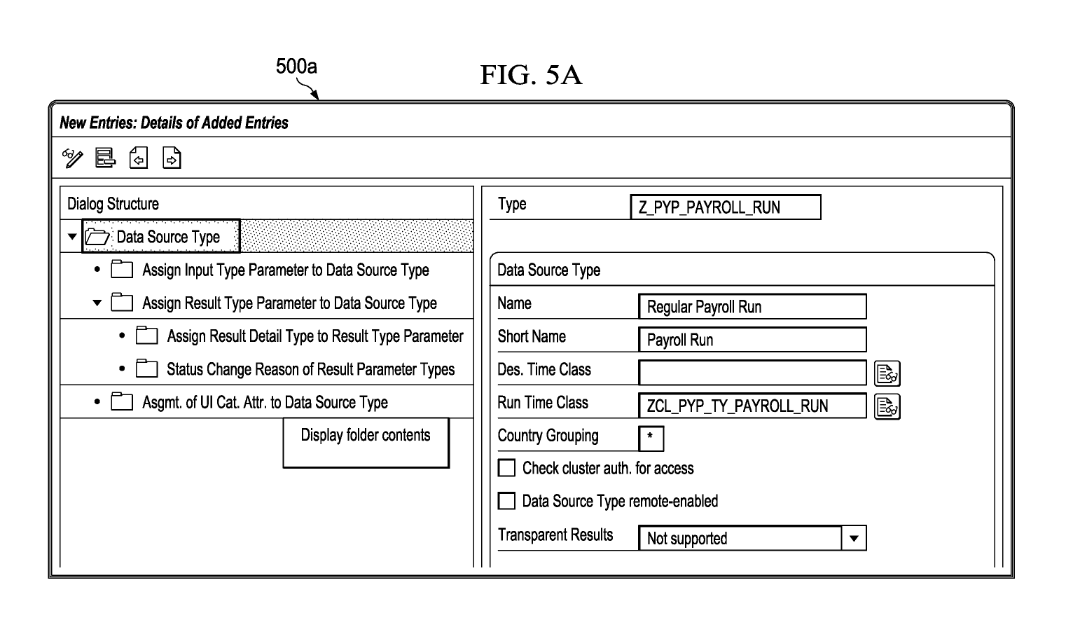

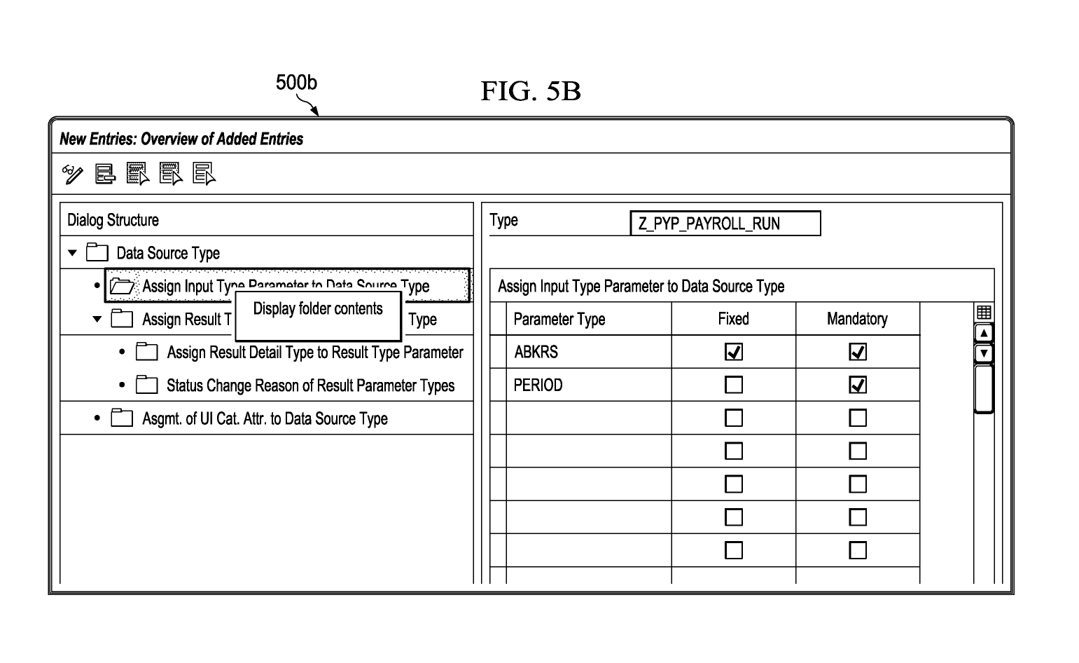

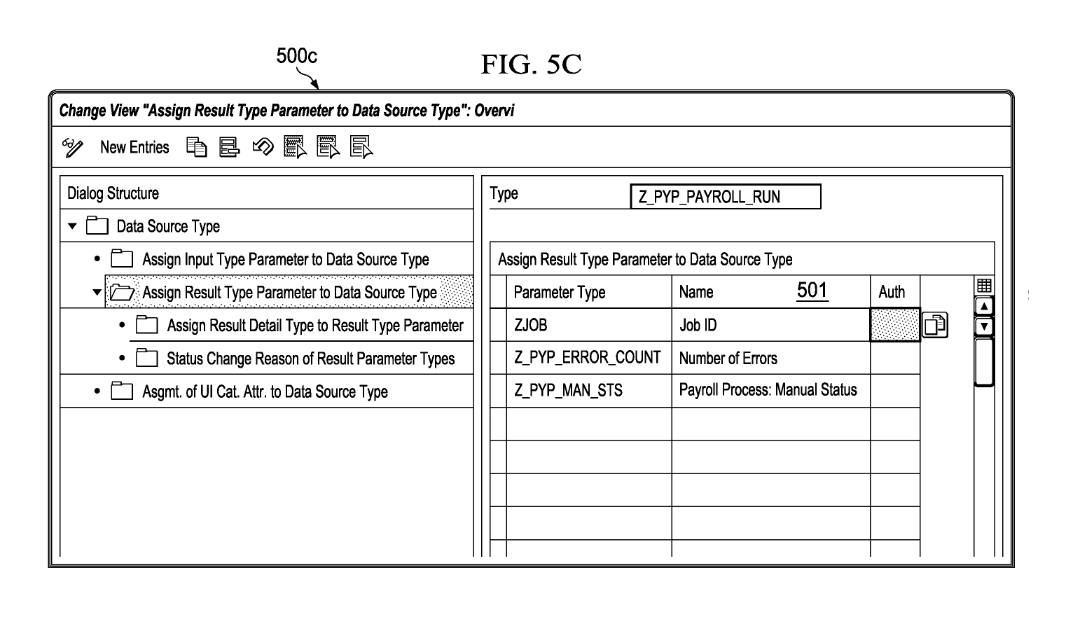

FIG. 5A illustrates example graphical user interface 500a at a client device for starting a new meta-model for a portion (e.g. a step or an operation) of a payroll process, and FIG. 5B illustrates example graphical user interface 500b at a client device for receiving a selection of an entity and for receiving a selection of a time information (e.g., a time period and/or a point in time). In an aspect, usually programs covering steps or operations of the payroll processes have one main selection entity like a group of employees for which payroll is run together (here called “Payroll Area”; other payroll systems may call the entity “company” or have other proprietary terms) or a legal employer etc. Additionally, the payroll process may process data for a certain period of time, such as the payroll period (a month, a week, etc.), a quarter, or another suitable period. As outlined above, the meta-model may be implemented as a computer-implemented method for modeling one or more steps or operations of a payroll process in a graphical user interface at a client computing device, the method comprising: receiving, at the graphical user interface, a selection of an entity; receiving, at the graphical user interface, a selection of a time information; assigning the selected entity and the selected time information to a payroll process; executing, by a server remote to the client device, the payroll process by using the selected entity and the selected time information; and receiving, at the graphical user interface, a status report about the execution of the payroll process. This may lead to the introduction of the following two concepts: (i) Instance Selection Parameter Type (e.g, the above mentioned selected “entity”) and (ii) Time Selection Parameter Type (e.g, the above mentioned selected “time information”).

The Instance Selection Parameter Type may be the main selection entity type used for a certain payroll process type. For instance, the Payroll Area is used for performing the preparation and calculation of the regular payroll results. In one example, the Instance Selection Parameter Type may be assigned to the Data Source Class (e.g., the payroll process template) and tells the user of the client device 150a, 150b how the individual process steps (e.g., Data Source Types and Instances) can be configured. In an aspect, the programs performing the individual process steps may understand values of that type as input data—or at least a mapping exists between Instance Selection Parameter values and the input data such a program is able to deal with.

In an aspect of the meta-model, the Time Selection Parameter Type is an entity type describing the period of time relevant for a certain payroll process instance. For example this can be a payroll period for which a regular payroll calculation runs. In an aspect of the meta-model, the Time Selection Parameter Type is also assigned to the Data Source Class and tells a generic consumer how process step instances (=Data Source Results) are created. The programs performing the individual process steps can understand values of that type as input data, or a mapping may exist between Time Selection Parameter values and the input data such a program is able to deal with.

In an aspect of the meta-model, these Parameter Types may have implementations that allow getting further information about their values from the existing data available in the payroll system, such as begin and end dates corresponding to a Time Selection Parameter value. This, in turn, may then allow the system to enrich generic user interfaces with such information.

In the following, the concept how to configure that the meta-model is shown in an exemplary way. The step template for a regular payroll run that usually requires the payroll area and a period as input information (apart from some administrative information that can already be configured in the underlying system) is illustrated. For the implementation, coding can be assigned to the configuration, here shown as class of the corresponding programming language. In the exemplary embodiment of the meta-model in FIG. 5B, the payroll area (ABKRS=“Abrechnungskreis” in German) and the payroll period may be required. The corresponding program name is not configured here because it can be derived from the country in the underlying system. The Data Source Type is valid for all countries but the corresponding Data Source Instances have to specify for which country they run. In other words, at run time the name of the program can be determined automatically and is not required as input parameter type. In FIG. 5C, three Result Parameter Types 501 are chosen in graphical user interface 500c: a status for the whole step that can be manually set by some operations, the identifier of the batch job that performs the step's program, and a number of errors that might come out of the program run.

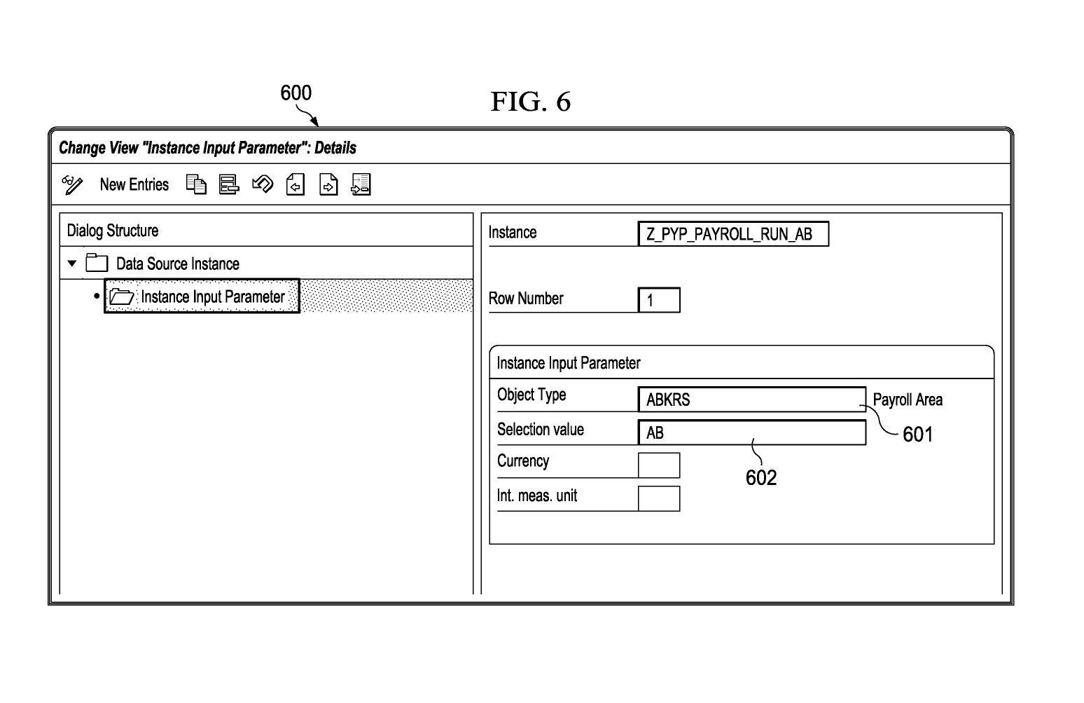

FIG. 6 illustrates example graphical user interface 600 at a client device for specifying a received selection of an entity. In previous examples, the step template has been modeled. However, the payroll area that the step template is to be used must be specified. This may require two steps: (1) the creation of the Data Source Instance for that Data Source Type and (2) the specification of that input parameter for this new Instance. This may mean that first a Data Source Instance may be created for the Data Source Type and in this Instance the Input Parameter Type 601 “Payroll Area” is assigned a particular value 602 (here: “AB”). In an aspect of the meta-model, the executing of the payroll process is then performed by using the selected entity and the selected time information and the executing comprises: accessing one or more databases including data associated with the selected entity or the selected time information, wherein the one or more databases are communicatively connected with the server via a LAN or WAN. In an aspect, when that Instance is executed, the framework may determine the payroll period based on some existing administrative information for the payroll area (e.g., a control record), fill administrative tables, and call the Data Source Type's execution method to determine the Result Object values. In an aspect of the meta-model, the created step template (e.g., Data Source Type) is assigned a payroll process template, e.g. in the meta-model, the new Data Source Type is placed in a folder of a Data Source Class.

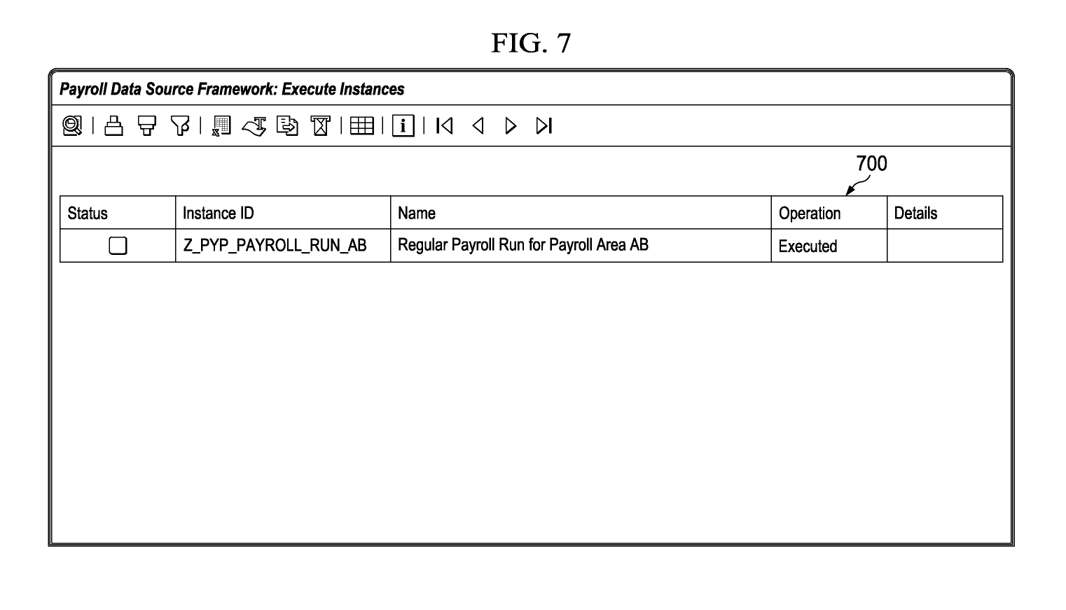

FIG. 7 illustrates example graphical user interface at a client device for receiving a status report 700 about the execution of the payroll process. In an aspect of the meta-model, a status report 700 (e.g., status report 407b of FIG. 4B) associated with and/or describing the execution of the payroll process is provided for display at the graphical user interface of the client device 150a, 150b. For example, the status report may include at least one of a degree to which the payroll process is executed, a degree to which the payroll process is not executed, a degree to which the selected entity or the selected time information is processed by the payroll process, and a time required until the payroll process will be finished executing by using the selected entity and the selected time information.

FIG. 8 illustrates an exemplary method or process 800 for providing a meta-model for modeling one or more payroll processes in a graphical user interface at a client computing device 150a, 150b. Client device 150a, 150b may be connected with remote server 102 via network 140 (e.g, LAN or WAN) and the remote server 102 may be connected to one or more databases 120 via a network (e.g., LAN or WAN) connection. The remote server 102 and/or the database 120 may be implemented in a cloud computing environment 820.

At 806, the client device 150a, 150b receives a selection of an entity and a selection of a time information (e.g., a time period or a point in time), and optionally a selection of one or more result parameters.

At 807, the remote server 102 receives the selected entity and the selected time information, assigns the selected entity and the selected time information to one or more operations of a payroll process, and executes the operation of the payroll process by using the selected entity and the selected time information, and optionally the selected results parameter. Result parameters of a process step or operation (e.g., Data Source Result) may be one or more of the following:
“Execution Status”: describes whether the step instance has already been opened, is currently running or is closed and locked against changes.
“Error Status”: describes whether the step instance has already been checked for errors. If yes, it shows whether errors occurred or not. Typical status values: “not specified”/“in preparation”/“OK”/“Error”. Usually this status is accompanied by an error count and is calculated based on a list of checks that have been performed. Those checks can be manual or system-based, and usually their results are reflected by own status information.
Action Log: contains information about all activities in context with that step instance, like changing the execution status, solving errors, corresponding user and time stamp. It also allows to add comments or upload attachments for further information.
further step specific information, if required, like a list of employees rejected by the payroll run.

At 808a, the remote server 102 accesses one or more databases including data associated with the selected entity and/or the selected time information and may retrieve data from the accessed database for execution of the payroll process.

At 809, the client device 150a, 150b receives a status report from the server 102, 120 about the execution of the operation of the payroll process, wherein the status report may include at least one of a degree to which the operation of the payroll process is executed, a degree to which the operation of the payroll process is not executed, a degree to which the selected entity or the selected time information is processed by the payroll process, and a time required until the operation of the payroll process will be finished executing by using the selected entity and the selected time information.

At 810, the remote server may (e.g., subsequent to operation 807 or 809) receive a change to the payroll process (e.g., a modification of an operational step of an existing assigned payroll process, or an addition of an additional operation or of a payroll process to the assigned payroll process) and execute the changed payroll process by using the selected entity and the selected time information without having to reassign the selected entity and time information to the changed payroll process. For example, the plurality of payroll process currently monitored by the meta-model may be augmented by an additional operation of a payroll process for another country, wherein the meta-model may not need to be modified to be able to monitor the additional operation. For example, only certain metadata for this additional payroll process may need to be stored in the meta-model, but the structure of its above described components (Data Sources, Input Parameter Types, Data Source Instances, Data Source Results) may not need to be modified.

At 808b, the remote server 102 accesses one or more databases including data associated with the selected entity and/or the selected time information and may retrieve data from the accessed database for execution of the changed payroll process.

At 811, the client device 150a, 150b receives a status report from the server 102, 120 about the execution of the changed operation of the payroll process, wherein the status report may include at least one of a degree to which the operation of the payroll process is executed, a degree to which the operation of the payroll process is not executed, a degree to which the selected entity or the selected time information is processed by the operation of the payroll process, and a time required until the operation or the payroll process will be finished executing by using the selected entity and the selected time information.

The preceding figures and accompanying description illustrate example processes and computer implementable techniques. But network environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, each network environment may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art.

What is claimed is:

1. A computer-implemented method for modeling one or more operations of a payroll process in a graphical user interface at a client computing device, the method comprising:
receiving, at a server and from the client computing device, a selection of an entity;
receiving, at the server and from the client computing device, a selection of a time information;
assigning, by the server, the selected entity and the selected time information to one or more operations of a payroll process;
executing, by the server, the operation of the payroll process by using the selected entity and the selected time information; and
providing, by the server to the client computing device, a status report about the execution of the operation of the payroll process.

2. The method of claim 1, further comprising:
receiving, at the server and from the client computing device, a selection of one or more result parameters; and
determining, by the server, the selected one or more result parameters by using the operation of the payroll process.

3. The method of claim 2, wherein the one or more result parameters includes at least one of: a number of errors in the executed payroll process, an identifier of the executed payroll process, a tax to be paid, a status of the payroll process, whether the operation has already been opened, is currently running or is closed and locked against changes, or log information about the operation.

4. The method of claim 1, wherein the executing of the operation of the payroll process by using the selected entity and the selected time information comprises:
accessing, by the server, one or more databases including data associated with the selected entity or the selected time information.

5. The method of claim 1, wherein the assigning of the selected entity and the selected time information to one or more operations of a payroll process is performed by the server using the OData-protocol.

6. The method of claim 1, wherein the status report includes at least one of a degree to which the operation of the payroll process is or is not executed, a degree to which the payroll process is or is not executed, a degree to which the selected entity or the selected time information is processed by the operation of the payroll process, and a time required until the operation of the payroll process will be finished executing by using the selected entity and the selected time information.

7. The method of claim 1, wherein the time information is a time period or a point in time, and wherein the entity is one or more employees or a legal entity.

8. The method of claim 1, further comprising:
receiving, by the server, a change to the operation of the payroll process and executing, by the server, the changed operation of the payroll process by using the selected entity and the selected time information either without having to change the modeling of the operation of the payroll processes in the graphical user interface at the client computing device or without having to reassign the selected entity and time information to the changed operation of the payroll process

9. The method of claim 1, wherein the operation of the payroll process is executed in a cloud computing environment or in an in-memory database.

10. The method of claim 1, further comprising:
receiving, by the server, a command to add an additional operation of a payroll process to the executing operation of the payroll process to form a plurality of payroll process operations and executing, by the server, the plurality of payroll process operations by using the selected entity and the selected time information without having to reassign the selected entity and time information to the executing operation of the payroll process, or without having to change the modeling of the one or more operations of the payroll process in the graphical user interface at the client computing device.

11. A computer-method for modeling one or more operations of a payroll process in a graphical user interface at a client computing device, the method comprising:
identifying, at the client computing device, a selection of an entity;
identifying, at the client computing device, a selection of a time information;
transmitting, from the client computing device to a server remote from the client computing device, the selected entity and the selected time information;
receiving, at the client computing device and from the server, a status report about a remote execution of the operation of the payroll process that uses the selected entity and the selected time information.

12. A computer program product encoded on a tangible storage medium, the product comprising computer readable instructions for causing one or more computers to perform operations for modeling one or more operations of a payroll process in a graphical user interface at a client computing device, the operations comprising:
identifying, at the client computing device, a selection of an entity;
identifying, at the client computing device, a selection of a time information;
transmitting, from the client computing device to a server remote from the client computing device, the selected entity and the selected time information;
receiving, at the client computing device and from the server, a status report about a remote execution of the operation of the payroll process that uses the selected entity and the selected time information.

13. A computer program product encoded on a tangible storage medium, the product comprising computer readable instructions for causing one or more computers to perform operations for modeling one or more payroll processes in a graphical user interface at a client computing device, the operations comprising:
receiving, at a server and from the client computing device, a selection of an entity;
receiving, at the server and from the client computing device, a selection of a time information;
assigning, by the server, the selected entity and the selected time information to one or more operations of a payroll process;
executing, by the server, the operation of the payroll process by using the selected entity and the selected time information; and
providing, by the server to the client computing device, a status report about the execution of the operation of the payroll process.

14. The computer program product of claim 13, further comprising:
receiving, at the server and from the client computing device, a selection of one or more result parameters and determining, by the server, the selected one or more result parameters by using the payroll process, wherein the one or more result parameters includes at least one of a number of errors in the executed payroll process, an identifier of the executed payroll process, a tax to be paid, or a status of the payroll process.

15. The computer program product of claim 13, wherein the executing of the payroll process by using the selected entity and the selected time information comprises:
accessing, by the server, one or more databases including data associated with the selected entity or the selected time information, wherein the one or more databases are communicatively connected with the server via a LAN or WAN.

16. The computer program product of claim 13, wherein the status report includes at least one of degree to which the payroll process is executed, degree to which the payroll process is not executed; degree to which the selected entity or the selected time information is processed by the payroll process; time required until the payroll process will be finished executing by using the selected entity and the selected time information.

17. The computer program product of claim 13, further comprising:
receiving, by the server, a change to the payroll process and executing, by the server, the changed payroll process by using the selected entity and the selected time information without having to change the modeling of the operation of the payroll process in the graphical user interface at the client computing device, or without having to reassign the selected entity and time information to the changed payroll process.

18. The computer program product of claim 13, further comprising:
receiving, by the server, a command to add an additional operation of a payroll process to the executing operation of the payroll process to form a plurality of payroll process operations and executing, by the server, the plurality of payroll process operations by using the selected entity and the selected time information without having to reassign the selected entity and time information to the executing payroll process or without having to change the modeling of the operation of the payroll process in the graphical user interface at the client computing device.

19. A system for providing for modeling one or more operations of a payroll process in a graphical user interface at a client computing device, the system comprising:
the client computing device configured to:
receive a selection of an entity; and
receive a selection of a time information; and
a server remote from the client computing device, the server configured to:
assign the selected entity and the selected time information to a payroll process;
execute the payroll process by using the selected entity and the selected time information; and
transmit a status report about the execution of the payroll process to the client computing device.

20. The system of claim 19, wherein the client computing device is communicatively connected with the server via a LAN or WAN.

21. The system of claim 19, wherein the server is further configured to:
access, during the executing of the payroll process by using the selected entity and the selected time information, one or more databases storing data associated with the selected entity or the selected time information, wherein the one or more databases are communicatively connected with the server via a LAN or WAN.

22. The system of claim 19, wherein the one or more operations of the payroll process are implemented in a cloud computing environment.

23. A system for providing for modeling one or more operations of a payroll process in a graphical user interface at a client computing device, the system comprising:
the client computing device configured to:
receive a selection of an entity; and
receive a selection of a time information; and
a server remote from the client computing device, the server configured to:
assign the selected entity and the selected time information to one or more operations of a payroll process;
execute the operations of the payroll process by using the selected entity and the selected time information;
access, during the executing of the operation of the payroll process by using the selected entity and the selected time information, one or more databases storing data associated with the selected entity or the selected time information;
receive a change to the operation of the payroll process and execute the changed operation of the payroll process by using the selected entity and the selected time information without having to change the modeling of the one or more operations of the payroll processes in the graphical user interface at the client computing device, or without having to reassign the selected entity and time information to the changed operation of the payroll process; and
transmit a status report about the execution of the changed operation of the payroll process to the client computing device.
